(19) United States
(12) Patent Application Publication
(10) Pub. No.: US 2021/0279161 A1
(43) Pub. Date: Sep. 9, 2021

(54) EVENT MANAGEMENT SYSTEM AND METHOD

(71) Applicant: HITACHI, LTD., Tokyo (JP)

(72) Inventor: Takashi TAMESHIGE, Tokyo (JP)

(73) Assignee: HITACHI, LTD., Tokyo (JP)

(21) Appl. No.: 17/016,906

(22) Filed: Sep. 10, 2020

(30) Foreign Application Priority Data
Mar. 9, 2020 (JP) 2020-039617

(51) Int. Cl. G06F 11/32; G06F 11/30; G06F 11/07; G06K 9/62; G06F 16/332; G06N 5/02

(52) U.S. Cl. CPC G06F 11/327; G06F 11/3072; G06F 11/0772; G06N 5/025; G06K 9/6215; G06F 16/3329; G06F 11/076

(57) ABSTRACT

An event management system includes: a rule management table that defines situation occurrence conditions and the type of feedback; a handling instruction sheet allocation unit that, when a new arrival event occurs, extracts a handling instruction sheet to be assigned to the new arrival event, transmits the extracted handling instruction sheet to a terminal, and receives a feedback regarding the success or failure of allocation of the handling instruction sheet from the terminal; and a feedback processing unit that detects whether or not the feedback is erroneous with reference to the rule management table. When an error in the feedback is detected, the feedback processing unit notifies the terminal of the error.

### BACKGROUND OF THE INVENTION

### 1. Field of the Invention

The present invention relates to an event management system and method, and in particular, to management of events in IT (information technology) services.

### 2. Description of the Related Art

Event monitoring is one of the operations of IT systems that provide IT services. In an important information system used for core business in a company, when an event such as a malfunction or abnormality occurs, an event is issued. For example, JP 2020-9154 A discloses an event management system that monitors events that occur in an information system, and in particular, a technique for improving the determination of how guides are associated with events that occur in an information system.

In recent years, with the rapid development of digital technology, many companies are using some IT services including cloud. Under such circumstances, it is also reported that a huge amount of cost is spent due to failures including IT service outages. The cost of IT Ops as the maintenance cost of IT services tends to rise. Against this background, the number of companies that promote automation and autonomy of IT operations (IT Ops) is increasing.

Movement for applying AI (Artificial Intelligence) to IT Ops to promote automation and autonomy is called AIOps. Technology areas where AIOps are under progress are correlation analysis, such as clustering or meaning of abnormality detection alerts, and noise removal for abnormality detection alerts. The main use case is an application to “skillful work”. “Skillful work” is a work that requires data analysis skills, and is a work performed by human resources who know what algorithm to apply to event or performance data for data analysis.

On the other hand, at the site of IT Ops, there is a work that is processed by human labors depending on the individual site or situation and the target IT system, and there is a “work that can only be done by human beings” that is a work performed by the human labors of multiple teams because it is not possible to completely rule out the human labors even though some degree of standardization or automation is becoming widespread.

“Work that can only be done by human beings” has high customer needs because the return on investment is easy to see. As an example of the “work that can only be done by human beings”, there is an event operation. This is to perform work corresponding to the event notified from the IT system with high accuracy based on the ambiguously defined handling instruction sheet. Since only a well-trained IT operator can work even with “ambiguous instruction”, it is difficult for a program to interpret and perform the same work. It is expected that the automation of the event operation will be realized by the approach of replacing this training part with “machine learning and prediction result feedback”.

The event operation is one of the monitoring of IT systems, which is the basis of IT Ops. An event monitoring server receives events, each of which includes “date and time” and “message body”, from a server or business applications 10,000 events/day or more. The IT operator visually checks that the received event is an abnormal event, and refers to the handling instruction sheet to act according to the written instructions. The message body of the event is described in the handling instructions, and the IT operator searches for an appropriate handling instruction sheet based on the message body. Handling instructions described in the handling instruction sheet are, for example, a method of reporting to the higher-level administrator and a simple work instruction (such as issuing a command to check the status of a server or application and collecting a result or collecting information such as error logs).

It is thought that an operation, in which IT Ops using feedback are optimized as teacher data for machine learning, can be realized by using the technique disclosed in JP 2020-9154 A. However, since a feedback is usually provided by human beings, the risk of incorrect feedback cannot be ruled out. If the incorrect feedback can be easily detected, the adverse effect of the incorrect feedback can be canceled by overwriting the feedback.

However, there is a problem that the incorrect feedback is difficult to understand at first glance and, in the case of event operation, the situation is not apparent until the incorrect feedback is canceled with correct feedback after recognizing that the “handling instruction sheet that should be allocated is not available”.

### SUMMARY OF THE INVENTION

It is an object of the invention to specify an incorrect feedback to obtain accurate data and present a correct handling instruction sheet.

According to an aspect of the invention, there is provided an event management system that manages an event occurring in a monitoring target using a computer and a terminal. The event management system includes: a rule management table that defines situation occurrence conditions and a type of feedback; a handling instruction sheet allocation unit that, when a new arrival event occurs, extracts a handling instruction sheet to be assigned to the new arrival event, transmits the extracted handling instruction sheet to the terminal, and receives a feedback regarding success or failure of allocation of the handling instruction sheet from the terminal; and a feedback processing unit that detects whether or not the feedback is erroneous with reference to the rule management table. When an error in the feedback is detected, the feedback processing unit notifies the terminal of the error.

According to another aspect of the invention, there is provided an event management method operated in an event management system.

According to the invention, it is possible to specify an incorrect feedback to obtain accurate data and present a correct handling instruction sheet.

### BRIEF DESCRIPTION OF THE DRAWINGS

FIG. 1 is a diagram illustrating the configuration of a computer system according to an embodiment;

FIG. 2 is a diagram illustrating the configuration of a management system;

FIG. 3 is a diagram illustrating the configuration of a server;

FIG. 4 is a diagram illustrating an outline of processing in the management system;

FIG. 5 is a diagram illustrating the configuration of an event management table;

FIG. 6 is a diagram illustrating the configuration of a handling instruction sheet management table;

FIG. 7 is a diagram illustrating the configuration of a feedback rule management table;

FIG. 8 is a diagram illustrating the configuration of a feedback history management table;

FIG. 9 is a diagram illustrating a feedback outline;

FIG. 10 is a diagram illustrating the configuration of a rule management table;

FIG. 11 is a diagram illustrating the flow of an incorrect feedback detection process;

FIG. 12 is a diagram illustrating the flow of an incorrect feedback correction process;

FIG. 13 is a diagram illustrating an example of a result screen when feedback statistical information includes incorrect feedback; and

FIG. 14 is a diagram illustrating an example of a result screen when feedback history information includes incorrect feedback.

### DETAILED DESCRIPTION OF THE PREFERRED EMBODIMENTS

In a preferred embodiment of the invention, in a management system, an event issuing program of a monitoring target system provides event notification of system information regarding the monitoring target system. The event is transmitted to an event management program of the management system, and the event management program that receives the event stores the event in the event management table. A handling instruction sheet allocation program refers to the event management table, and when a new arrival event is detected, extracts a handling instruction sheet to be allocated to the new arrival event with reference to a handling instruction sheet management table. The extracted handling instruction sheet is displayed on the operator's terminal. As described in the handling instruction sheet, the operator registers escalation information from the terminal when escalation to the higher-level administrator is necessary. The handling instruction sheet allocation program transmits the escalation information to the terminal of the higher-level administrator. Feedback regarding the success or failure of the allocation of the handling instruction sheet can be registered in the handling instruction sheet allocation program. The feedback information is registered in a feedback history management table by the handling instruction sheet allocation program. Feedback is registered by the higher-level administrator or operator. A control program (for example, a feedback processing program) that detects that the feedback information is registered detects whether or not unintended feedback has occurred with reference to a rule management table. When the occurrence of unintended feedback (incorrect feedback) is detected, the control program notifies the terminal of the higher-level administrator or the terminal of the operator of the detection and displays a wrong candidate. Events include normal events and abnormal events.

### First Embodiment

Hereinafter, an embodiment of an event operation will be described with reference to the diagrams.

In the following description, an “interface unit” includes one or more interfaces. The one or more interfaces may be one or more same type of interface devices (for example, one or more NICs (Network Interface Cards)), or may be two or more different types of interface devices (for example, NICs and HBAs (Host Bus Adapters)).

In addition, in the following description, a “storage unit” includes one or more memories. At least one memory may be a volatile memory or a non-volatile memory. The storage unit may include one or more HDs in addition to one or more memories. The “HD” means a physical storage device, and may typically be a non-volatile storage device (for example, an auxiliary storage device). The HD may be, for example, an HDD (Hard Disk Drive) or an SSD (Solid State Drive).

In addition, in the following description, a “processor unit” includes one or more processors. At least one processor is typically a CPU (Central Processing Unit). The processor may include a hardware circuit that performs entire processing or a part of the processing.

In addition, in the following description, processing may be described by using a “program” as a subject, but the program is executed by the processor unit. Therefore, since predetermined processing is performed while appropriately using at least one of the storage unit and the interface unit, the subject of the processing may be the processor unit (or a computer or a computer system having a processor unit). The program may be installed on a computer from the program source. The program source may be, for example, a program distribution server or a computer-readable storage medium. In addition, in the following description, two or more programs may be realized as one program, or one program may be realized as two or more programs.

In addition, in the following description, information may be described as an expression, such as “xxx table”, but the information may be expressed in any data structure. That is, in order to indicate that the information does not depend on the data structure, the “xxx table” can be referred to as “xxx information”. In addition, in the following description, the configuration of each table is an example, and one table may be divided into two or more tables or all or some of the two or more tables may be one table. In addition, in the following description, a set of one or more computers displaying display information may be referred to as a “management system”. When a management computer displays information on a display device of the management computer, the management computer may be the management system, or a combination of a management computer and a display computer may be the management system. In addition, in order to increase the speed of management processing or increase the reliability of management processing, processing equivalent to that of the management computer may be realized by a plurality of computers. In this case, the plurality of computers (when a display computer performs display, the display computer is also included) may be the management system. “Displaying display information” by the management computer may be displaying the display information on a display device of the management computer, or may be transmitting the display information to a remote display computer by the management computer.

In addition, in the following description, when the same type of elements are described without distinction, reference numerals of the elements may be used, and when the same type of elements are described separately, identification information allocated to the elements may be used. For example, when a server is described without making a distinction, this may be described as a server 102, and when individual servers are described separately, these may be described as a server # 1 and a server # 2.

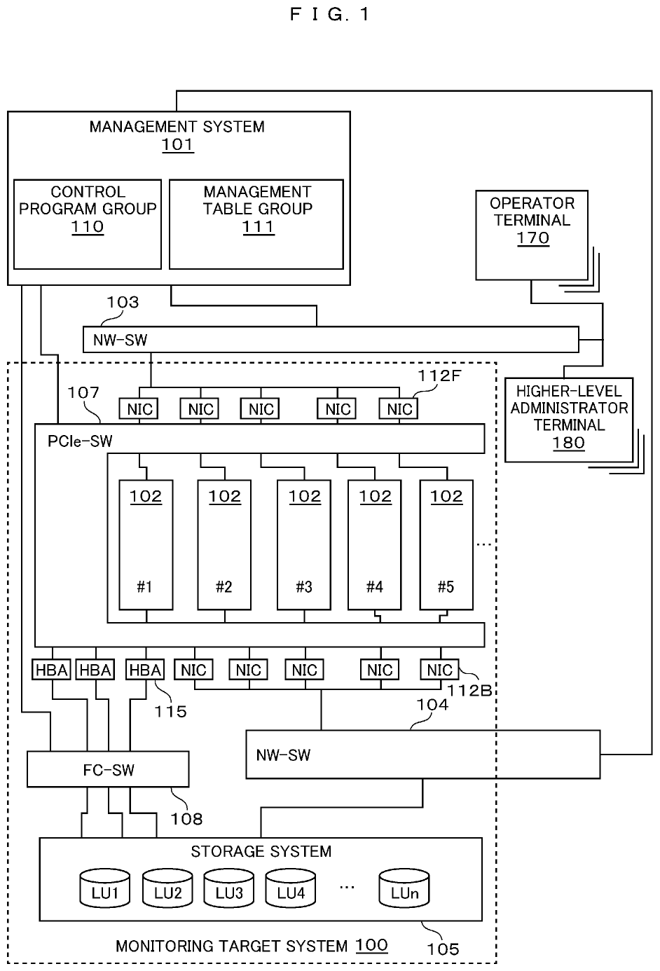

FIG. 1 illustrates the configuration of a computer system according to an embodiment.

The computer system includes a management system 101, a monitoring target system 100, an administrator terminal 180, and an operator terminal 170. The monitoring target system 100 is one or more computers, and is an IT system that provides business. In the present embodiment, the monitoring target system 100 is, for example, a server system including a plurality of servers (physical servers) 102 and a storage system providing a plurality of LUs (Logical Units). Each of the plurality of servers 102 included in the storage system is a monitoring target.

The administrator terminal 180 is an information processing terminal (for example, a personal computer) handled by a higher-level administrator. There are one or more administrator terminals 180. The higher-level administrator is a member of at least one design team. The design team is a team that provides business in the monitoring target system 100.

The operator terminal 170 is an information processing terminal handled by the operator. There are one or more operator terminals 170. The operator is a member of at least one operation team. The operation team is a team that operates the service system. The operator may be, for example, an administrator of the service system or a user of the service system.

Each of the operator terminal 170 and the administrator terminal 180 has a display unit, an input unit, a processor unit, and a storage unit. For example, the processor unit executes a program, so that the management system 101 enables the input of the input unit or the output to the display unit. In addition, the input and output functions of the operator terminal 170 and the administrator terminal 180 may be referred to as a user interface (UI).

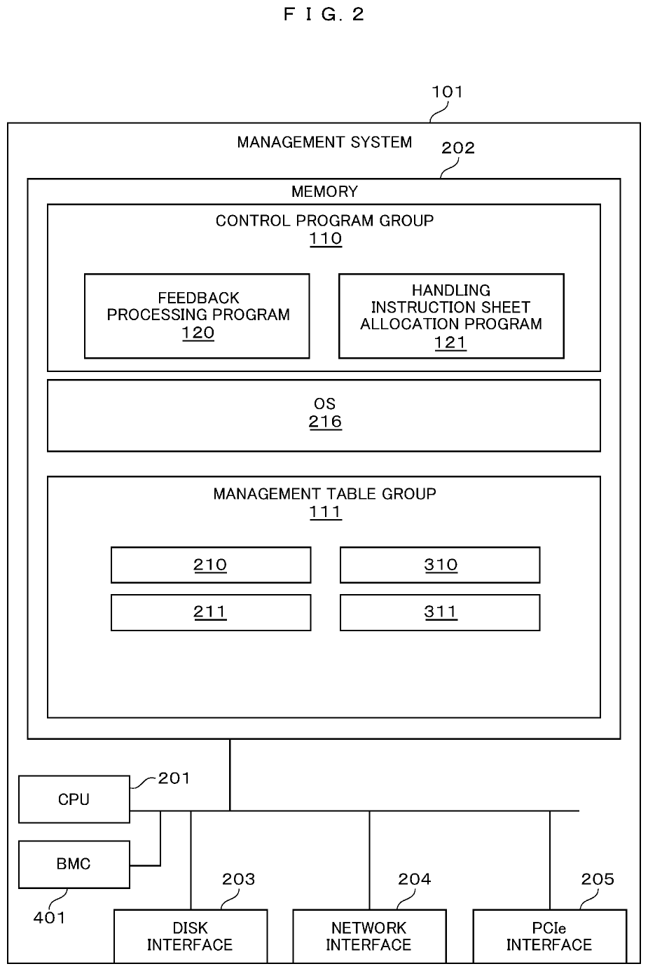

The management system 101 is one or more computers, and is an example of an inquiry response system having a control program group 110 and a management table group 111 (refer to FIG. 2 for details). The management system 101 is connected to management interfaces 114 of an NW-SW 103 (as an example of a management network) and an NW-SW 104 (as an example of a business network). The management system 101 can set a VLAN (Virtual LAN) in each of the NW-SWs 103 and 104. “NW-SW” is an abbreviation for a network switch. The NW-SW 103 is a network for the management system 101 to perform operation management, such as distribution of an OS (Operating System) or applications running on a plurality of servers 102 or power control. The NW-SW 104 is a network used by an application executed on the server 102. The NW-SW 104 is connected to a WAN (Wide Area Network) or the like and communicates with a client computer of the server system. The management system 101 is also connected to an FC-SW (fiber channel switch) 108. The FC-SW 108 is an example of an I/O (Input/Output) network. The management system 101 is connected to a storage system 105 through the FC-SW 108.

In the monitoring target system 100, each server 102 can execute a VM (virtual machine) as described later. The plurality of servers 102 are connected to the NW-SW 103 through a PCIe (PCI-Express)-SW 107 and a plurality of NICs (Network Interface Cards) 112F, are connected to the NW-SW 104 through the PCIe-SW 107 and the plurality of NICs 112F, and are connected to the FC-SW 108 through the PCIe (PCI-Express)-SW 107 and a plurality of HBAs (Host Bus Adapters). The NIC and the HBA are examples of an I/O device. In the computer system, the management network, the business network, and the I/O network may be integrated.

FIG. 2 illustrates the configuration of the management system 101.

The management system 101 is, for example, a computer, and has an interface unit, a storage unit, and a processor unit connected to these. The interface unit is, for example, a disk interface 203 for accessing the storage system 105, a network interface 204 for communication through the NW-SWs 103 and 104, and a PCIe interface 205 for communication through the PCIe-SW 107. The processor unit is, for example, a CPU 201. The storage unit is, for example, a memory 202, and the memory 202 stores the control program group 110, an OS 216, and the management table group 111. The control program group 110 includes a feedback processing program 120 and a handling instruction sheet allocation program 121, and these programs 120 and 121 and the OS 216 are executed by the CPU 201.

The management table group 111 includes an event management table 210, a handling instruction sheet management table 211, a feedback history management table 310, and a rule management table 311. In one example, the information registered in the management table group 111 may be information (raw information) collected by the handling instruction sheet allocation program 121 or the feedback processing program 120. Alternatively, the information registered in the management table group 111 may be information obtained by processing the information, or may be information input to the system administrator from a console (not illustrated) of the management system 101. At least a part of the management table group 111 may be stored in a storage device (not illustrated) other than the memory 202 or the storage system 105.

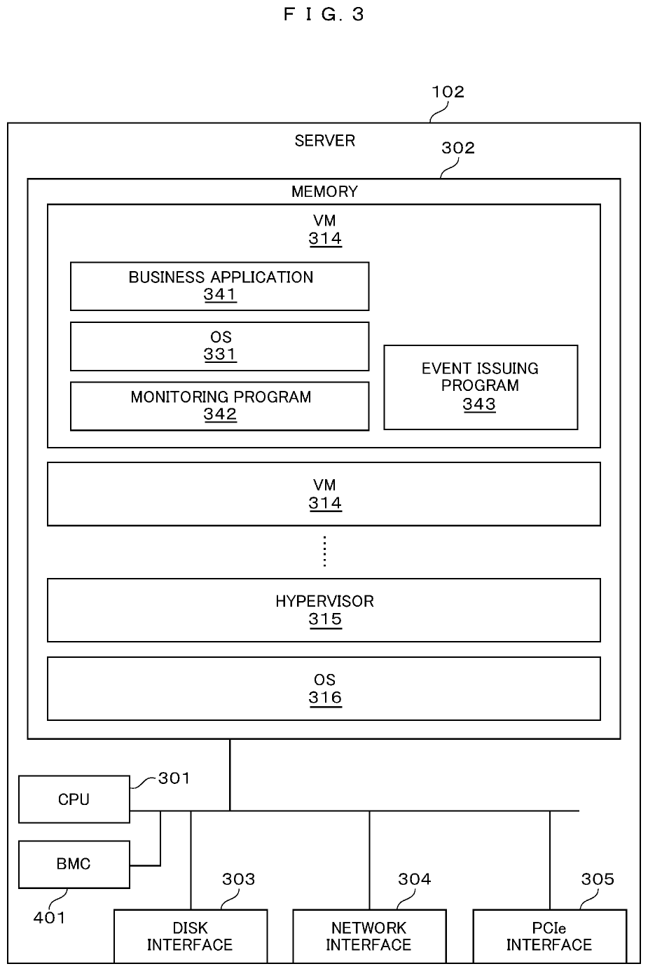

FIG. 3 illustrates the configuration of the server 102.

The server 102 of the monitoring target system 100 has a disk interface 303, a network interface 304, a PCIe interface 305, a memory 302, and a CPU 301 connected to these. The interfaces 303 to 305 have the same functions as the interfaces 203 to 205, respectively. The memory 302 executes an OS 316 and the hypervisor 315. The hypervisor 315 controls generation, activation, termination, and deletion of a VM 314. The VM 314 executes a business application (program) 341, an OS (for example, a guest OS) 331, and a monitoring program 342. The monitoring program 342 monitors the status of each component, such as the business application 341 and the OS 331, and outputs a log message indicating the status. A log file through which the log message is output is transmitted to the management system 101 as an event notification, and system information (information regarding the configuration, performance, failure, and the like) of internal devices (CPU 301, memory 302, disk interface 303, network interface 304, PCIe interface 305, and the like) of the server 102 is transmitted to the management system 101 as an event notification.

For example, the monitoring target system 100 may be divided into a plurality of subsystems by LPAR (Logical Partitioning). In addition, the VM equivalent or the inside thereof may be divided by container technology. A system including the plurality of subsystems may be a monitoring target.

Events issued from an event issuing program 343 and a BMC 401 of the monitoring target system 100 are transmitted to the management system 101 and stored in the event management table 210.

A handling instruction sheet is allocated from the event processed by the management system 101 and displayed on the operator terminal 170. Candidates for the handling instruction sheet are displayed on the operator terminal 170 or the administrator terminal 180. The operator understands the handling instruction with reference to the operator terminal 170, and performs the designated handling.

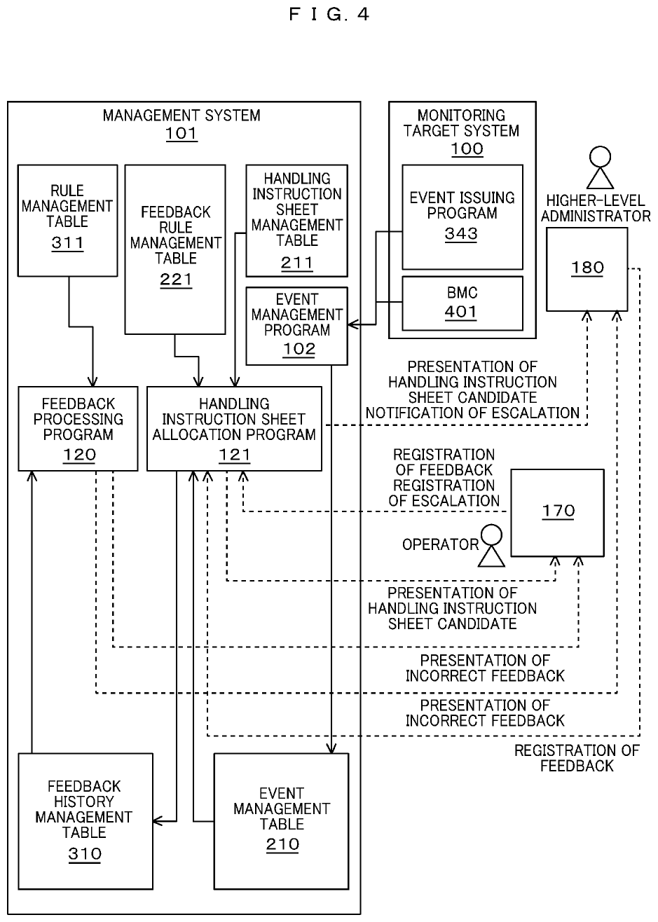

FIG. 4 illustrates an outline of processing in the management system according to the present embodiment.

In FIG. 4, a solid arrow means a process occurring between programs or between a program and a table, and a dashed arrow means a process occurring between the management system and the operator terminal 170 or the administrator terminal 180 (hereinafter, simply referred to as the terminal 170 or 180).

In the present embodiment, a handling instruction sheet allocation program 121 allocates handling instruction sheet candidates corresponding to the event that has occurred and displays the handling instruction sheet candidates on the display unit of the terminal 170. When the operator inputs “correct answer/incorrect answer/missing (not enough)” (that is, feedback registration) for the handling instruction sheet presented by the management system 101 through the input unit of the terminal 170, the input is stored in the feedback history management table 310. When a new feedback is detected, the feedback processing program 120 refers to the rule management table 311. At this time, when an incorrect feedback is detected, the terminals 170 and 180 are notified of “there is a possibility of incorrect feedback”.

The handling instruction sheet allocation program 121 morphologically analyzes the message body of the arrived event and the message body in the handling instruction sheet management table 211, and calculates the degree of matching between the sentences. Then, when the degree of matching is equal to or greater than a predetermined threshold value, it is determined that the handling instruction sheet is hit. The determination result is transmitted to the terminals 170 and 180 and displayed on the display units of the terminals. The threshold value is a value that differs for each handling instruction sheet in many cases, and the criterion of the degree of matching is calculated from past events using machine learning or the like. The threshold value is stored in the handling instruction sheet management table 211. Prior to the operation, calculation of machine learning is performed in advance using past events as teacher data, and threshold values are stored in the handling instruction sheet management table 211. In addition, if the teacher data is not sufficiently prepared, a default value may be applied.

The operator performs the handling based on the handling instruction sheet candidates presented to the terminals 170 and 180. When the presented handling instruction sheet is a correct answer, the threshold value in the handling instruction sheet management table 211 is correct. On the other hand, when the presented handling instruction sheet is an incorrect answer, the threshold value is not correct and accordingly should be corrected. For example, as a result of morphological analysis of the message body of a new arrival event to calculate the degree of matching, the degree of matching may be higher than the threshold value, but the presentation may not be valid. In this case, the handling instruction sheet allocation program 121 recalculates the threshold value, and the threshold value in the handling instruction sheet management table 211 is reset to a value higher than the above-described degree of matching so that the handling instruction sheet is not presented next.

The feedback input at the terminals 170 and 180 is transmitted to the management system 101 and stored in the feedback history management table 310. When new feedback is detected, the feedback processing program 120 checks whether or not there is an incorrect feedback with reference to the rule management table 311. When the feedback processing program 120 detects an incorrect feedback, the terminals 170 and 180 are notified of the fact that the incorrect feedback has been detected, and transmits incorrect feedback detection information to be displayed on the display unit. The higher-level administrator or the operator can recognize the content of the incorrect feedback by viewing the display.

Next, the configuration of various tables will be described.

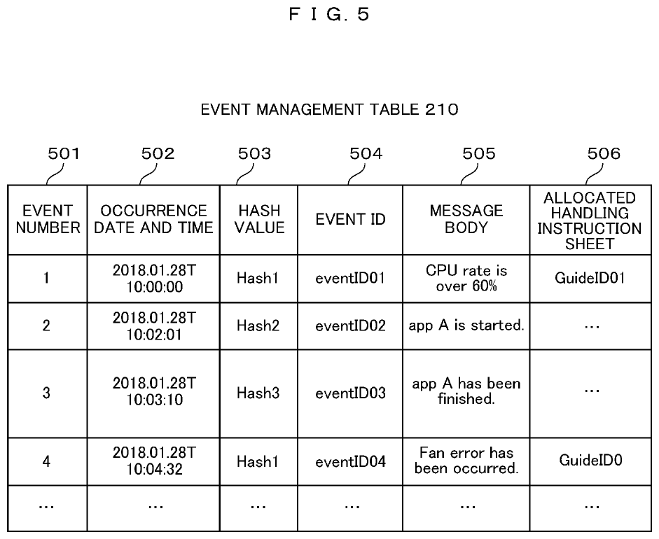

FIG. 5 illustrates the event management table 210.

An event that has occurred is stored in the event management table 210 regardless of failure or normal. The event management table 210 stores an occurrence date and time 502, a hash value 503, an event ID 504 unique to the event, a message body 505, and an allocated handling instruction sheet 506, corresponding to an event number 501 unique to the event. Here, the allocated handling instruction sheet 506 may store IDs indicating a plurality of handling instruction sheets. The degree of matching between a word matrix obtained as a result of morphological analysis on the message body 505 and a word matrix obtained as a result of morphological analysis on a message body 605 in the handling instruction sheet management table 211, which will be described later, is calculated.

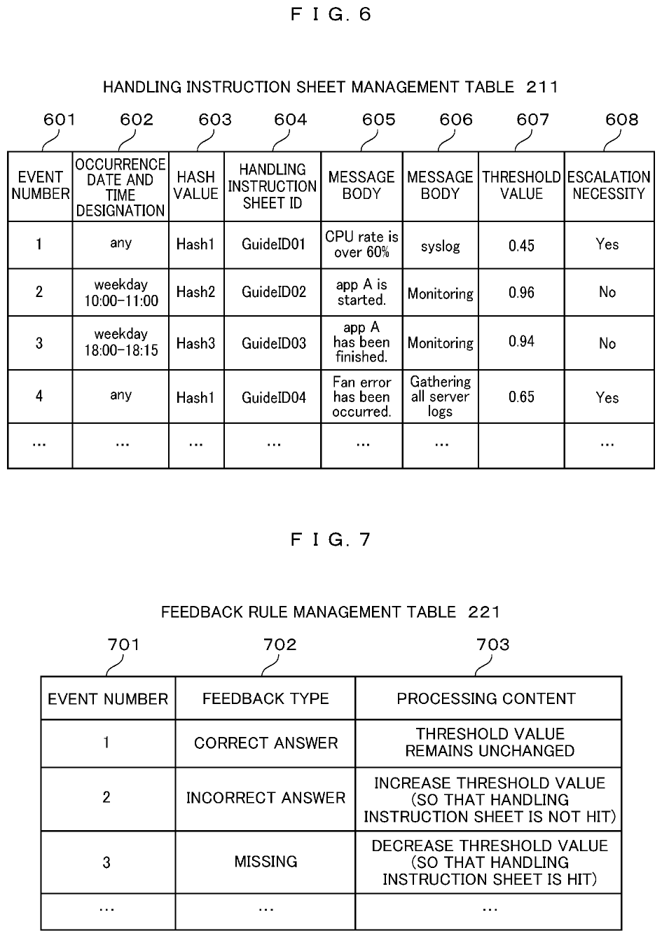

FIG. 6 illustrates the handling instruction sheet management table 211.

The handling instruction sheet management table 211 stores an occurrence date and time designation 602, a hash value 603, a handling instruction sheet ID 604 unique to the handling instruction sheet, the message body 605, a handling instruction 606, a threshold value 607, and an escalation necessity 608, corresponding to an event number 601. The threshold value 607 is calculated by performing morphological analysis on the message bodies of the past events, dividing the result into a word matrix, and calculating the degree of matching between the message bodies of the past events. Regarding the escalation necessity 608, not only YES/NO but also the conditions may be described. For example, the conditions may be set based on the execution result of the designated command, or the conditions based on statistical information such as the frequency of occurrence of the same type of event may be designated. The occurrence date and time designation 602 may be ANY (referred to whenever the event occurs), or may be a specific date and time designation.

FIG. 7 illustrates a feedback rule management table 221.

The feedback rule management table 221 stores a feedback type 702 and a processing content 703, corresponding to an event number 701. The feedback type 702 and the processing content 703 form a set. When the feedback type 702 is “correct answer”, “threshold value remains unchanged”, that is, the threshold value is not changed. In the case of “incorrect answer”, the “threshold value is set to be larger than the degree of matching between the new arrival event and the handling instruction sheet”. This occurs because the degree of matching that exceeds the threshold value of the handling instruction sheet that should not be allocated is calculated. Accordingly, the threshold value is changed to be increased. In the case of “missing”, the “threshold value is set to be smaller than the degree of matching between the new arrival event and the handling instruction sheet”. This occurs because the degree of matching between the new arrival event and the handling instruction sheet is less than the threshold value of the handling instruction sheet to be allocated. Accordingly, the threshold value is changed to be decreased.

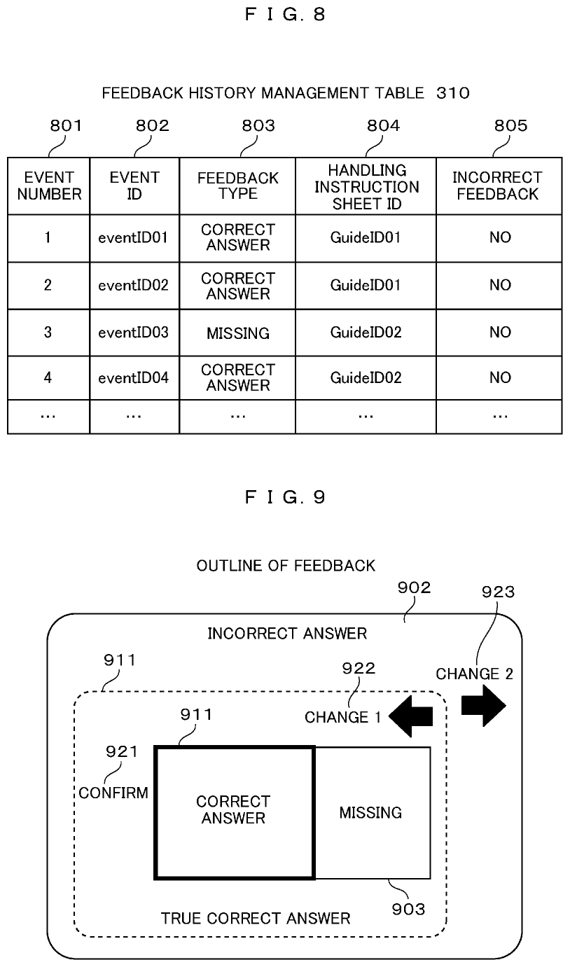

FIG. 8 illustrates the feedback history management table 310.

The feedback history management table 310 stores an event ID 802, a feedback type 803, a handling instruction sheet ID 804, and an incorrect feedback 805, corresponding to an event number 801. The feedback history management table 310 stores which handling instruction sheet is allocated to which event and the success or failure of the allocation as feedback. When an incorrect feedback is detected, YES is input in the incorrect feedback 805. In addition, correction can be made based on the rule management table 311.

FIG. 9 illustrates an outline of feedback.

In the present embodiment, the handling of feedback is defined as follows. “True correct answer” is a combination of “correct answer and missing”, and the others are “incorrect answer”. Then, the feedback that changes the boundary between the true correct answer and the incorrect answer (true incorrect answer) is “missing” and “incorrect answer”. The “correct answer” is a feedback that defines the boundary.

In FIG. 9, there is a true correct answer 911 configured to include a correct answer 901 and missing 903, and the others are an incorrect answer 902. By the feedback, this boundary can be divided into confirm 921 or change. There are two types of changes, that is, “change 1”: true correct answer 911 narrows 922 and “change 2”: true correct answer 911 widens 923. The certainty of feedback can be extracted depending on how the confirm 921 and the change 1: 922 or the change 2: 923 are connected. In addition, depending on how these are connected, it is possible to find a bug in the handling instruction sheet allocation program 121.

As an example, a situation is considered in which an “incorrect answer” is input after a “correct answer” has continued 30 times. What may be input next is that if the 30 “correct answers” until then are correct feedback, “missing” should be input in order to allocate the handling instruction sheet that is no longer available. In addition, assuming that the “missing” is correct, a “correct answer” is input next. This indicates that the previous “incorrect answer” was incorrect as a feedback. On the contrary, assuming the “incorrect answer” is correct and the “correct answer” is input next, the 30 “correct answers” until then are incorrect.

When this is dropped to the rule base, if this is expressed by the state change of “confirm” and “change (change 1 and change 2)”, it is possible to support combinations other than the three states of “correct answer”, “missing”, and “incorrect”. In other words, it is meaningful to make a rule by paying attention to the feedback for “confirm” and “change” of the boundary.

Regarding a bug, considering the case where the same handling instruction sheet receives “missing” and feedback after “missing” as an example, the threshold value is not appropriately changed in the first “missing”, and the handling instruction sheet that should be allocated is not allocated. Therefore, the second “missing” is input again. This indicates that the handling instruction sheet allocation program 121 does not operate correctly, and should be regarded as a bug.

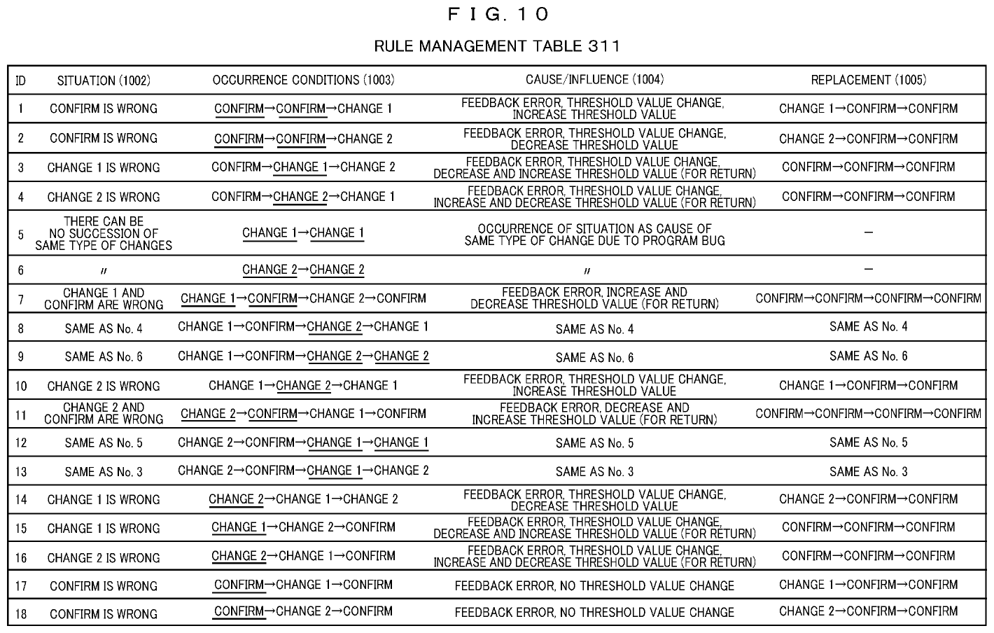

FIG. 10 illustrates the rule management table 311.

The rule management table 311 stores a situation 1002, rule/occurrence conditions 1003, a cause/influence 1004, and a replacement 1005, corresponding to an event number (denoted by reference numeral 1001). The rule/occurrence conditions 1003 store what-if conditions. In the case of matching with conditions, a situation for storage in the situation 1002 occurs, and can be concluded in the cause/influence 1004. In addition, the replacement 1005 stores a “path” in the case of a normal operation. The rule management table 311 is intended for the operation of returning to normal.

By viewing two to four feedbacks and their types with reference to the rule/occurrence conditions 1003, it is possible to detect an incorrect feedback (feedback error), and it is possible to specify which feedback is erroneous. In addition, “change” has symmetry between “change 1” and “change 2”. In addition, when the same “change” continues, this can be regarded as a bug of the handling instruction sheet allocation program 121. If confirm continues, the oldest confirm, the latest confirm, and change are viewed. Confirm on the way is skipped.

The replacement 1005 is used when it is desired to correct the feedback retroactively. Since the cause is specified, it is possible to make a rule as to where and how to make a correction to return to a healthy state. According to the replacement 1005, the incorrect feedback is corrected. By correcting the incorrect feedback, it is possible to obtain normal teacher data.

However, since it is a fact to present a handling instruction sheet and a feedback for the event occurring during the time, even if the incorrect feedback is corrected, it is possible to perform a statistical analysis on the past incorrect feedback by leaving the history.

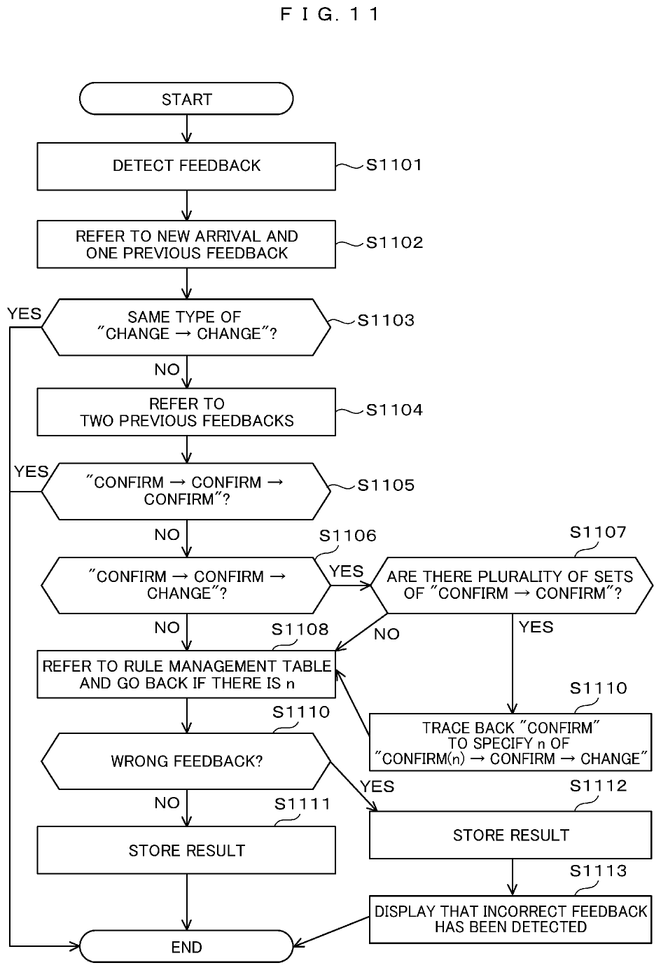

Next, an incorrect feedback detection process will be described with reference to FIG. 11. Here, S . . . indicates a processing step.

In step S1101, feedback is detected. The feedback is input by the operator or the higher-level administrator through the operator terminal 170 or the administrator terminal 180, and is transmitted to the handling instruction sheet allocation program 121. The handling instruction sheet allocation program 121 records (permanently makes) the feedback data in the feedback history management table 310. The feedback processing program 120 refers to the feedback history management table 310 and detects a feedback with the feedback data being made permanent as a trigger.

In step S1102, the feedback processing program 120 refers to “new feedback for new arrival event (new event ID)” in the feedback history management table 310. At the same time, the feedback processing program 120 refers to past feedback (one previous feedback) for the same handling instruction sheet, which is already stored in the feedback history management table 310.

In step S1103, the feedback processing program 120 refers to the rule management table 311 and determines whether or not the feedback is the same type of feedback, specifically, “change —>change”. The case where the determination result indicates the same type of feedback is a bug in the handling instruction sheet allocation program 121. This is because the same “change” is not presented continuously. Since there is a possibility of intentional input, it can be concluded that this is a bug or incorrect feedback. The feedback history management table 310 stores information indicating that this is an incorrect feedback and a bug (not illustrated).

If the result of the determination of “change —>change” in S1103 is different (in the case of No), the process proceeds to S1104.

In step S1104, the feedback processing program 120 refers to past feedbacks (two previous feedbacks) for the same handling instruction sheet, which is already stored in the feedback history management table 310.

In step S1105, the feedback processing program 120 refers to the rule management table 311 and determines whether or not the feedback type 702 is “confirm ->confirm —>confirm”. If the determination result is Yes, the process ends.

If the determination result is No, the process proceeds to S1106.

In step S1106, the feedback processing program 120 determines whether or not the past feedback type 702 already stored in the feedback history management table 310 is “confirm —>confirm —>change”. If the determination result is Yes, the process proceeds to S1107. If the determination result is No, the process proceeds to S1108.

In step S1107, the feedback processing program 120 determines whether or not the feedback type already stored in the feedback history management table 310 repeats “confirm —>confirm” multiple times. If the determination result is Yes, the process proceeds to S1109. If the determination result is No, the process proceeds to S1108.

In step S1109, the feedback processing program 120 traces back “confirm” that is repeated in the past feedback stored in the feedback history management table 310 to specify n of the oldest “confirm(n) —>confirm —>change”, and stores the incorrect feedback (Yes) and the number of times n (the number of times is not illustrated) in the incorrect feedback 805.

In step S1108, the feedback processing program 120 checks whether or not there is an incorrect feedback with reference to the feedback history management table 310. At this time, if n is passed, retroactive processing is performed up to the oldest “confirm” to specify the first incorrect feedback, and the process proceeds to S1110.

In step S1110, the feedback processing program 120 determines whether or not the feedback is incorrect based on the feedback stored in the feedback history management table 310 and the rule management table 311 (a table that stores rules in which the feedback is incorrect). If the determination result is Yes, the process proceeds to S1112. If the determination result is No, the process proceeds to S1111.

In step S1111, the feedback processing program 120 stores the determination result indicating that the feedback is not the incorrect feedback (No) in the incorrect feedback 805 of the feedback history management table 310, and ends the process.

In step S1112, the feedback processing program 120 stores the determination result indicating the incorrect feedback in the feedback history management table 310.

In step S1113, the feedback processing program 120 notifies the administrator terminal 180 and/or the operator terminal 170 that the incorrect feedback has been detected, and this is displayed on the display unit of the terminal.

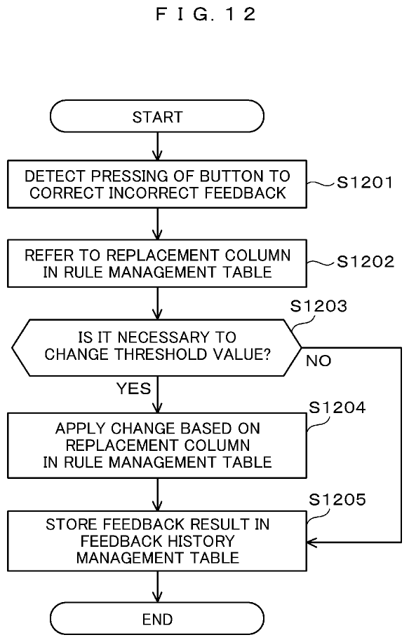

Next, an incorrect feedback correction process will be described with reference to FIG. 12. Here, S . . . indicates a processing step.

The feedback processing program 120 performs processing for correcting the feedback.

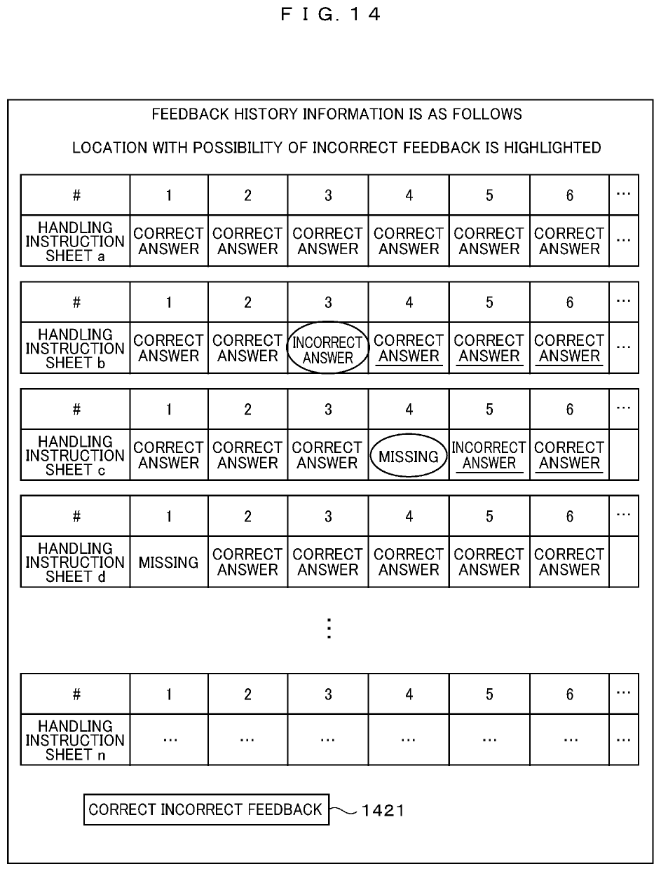

The feedback history information stored in the feedback history management table 310 is displayed on the display unit of the administrator terminal 180 or the operator terminal 170. FIG. 14 illustrates an example of the display screen. The operator or the higher-level administrator can check the feedback, which may be an incorrect feedback for each handling instruction sheet, on the screen displayed on the display unit of the operator terminal 170 or the administrator terminal 180. Then, the user operates the input unit to select a target handling instruction sheet, and presses a “correct incorrect feedback” button 1421.

In step S1201, the feedback processing program 120 detects (receives) the pressing of the “correct incorrect feedback” button 1421.

In step S1202, the feedback processing program 120 refers to the replacement 1005 in the rule management table 311.

In step S1203, the feedback processing program 120 determines whether or not the threshold value in the handling instruction sheet management table 211 needs to be changed. If the determination result is No, the process proceeds to S1205. If the determination result is Yes, the process proceeds to S1204.

In S1204, the feedback processing program 120 applies the change based on the replacement 1005 in the rule management table 311. At this time, the threshold value is not changed in the case of only “confirm”.

In step S1205, the feedback processing program 120 stores the feedback result in the incorrect feedback 805 in the feedback history management table 310 as a history, and ends the processing.

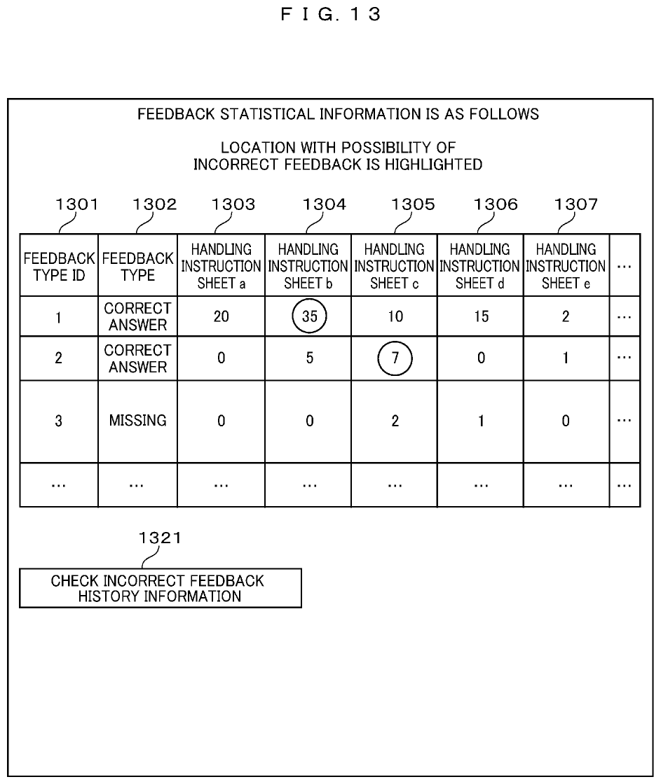

FIG. 13 illustrates an example of a display screen of feedback statistical information.

The feedback statistical information is obtained by statistically processing the information in the feedback history management table 310 by the feedback processing program 120, transmitted to the operator terminal 170 or the administrator terminal 180, and displayed on the screen. Regarding the display timing of the screen of the feedback statistical information, the feedback processing program 120 can calculate the statistical information of the feedback and transmit the feedback statistical information to the operator terminal 170 or the administrator terminal 180, for example, at a timing at which the incorrect feedback determination by the processing in FIG. 11 is completed. Alternatively, the operator or the administrator can display the feedback statistical information by operating a “check incorrect feedback history information” button 1321 on the display screen.

On this display screen, a feedback type 1302 and associated handling instruction sheets 1303 to 1307 are displayed corresponding to a feedback type ID 1301. Therefore, it is possible to refer to the statistical information of the feedback types “correct answer”, “incorrect answer”, and “missing” for each handling instruction sheet. A location with a possibility of incorrect feedback is highlighted (marked with a circle).

FIG. 14 illustrates an example of a display screen of feedback history information.

The display of feedback history information is performed by reading and processing the content of the feedback history management table 310 by the feedback processing program 120 and transmitting the content to the operator terminal 170 or the administrator terminal 180. The display timing may be when the feedback history information is registered in the feedback history management table 310, or may be set such that, when performing batch processing at regular intervals, batch processing is performed and display processing is performed.

On the display screen, a feedback history is displayed for each handling instruction sheet. By this display, it is possible to refer to which feedback is an incorrect feedback. The underlined feedback is a feedback considered as not being input due to the effect of incorrect feedback even though this should originally be input. A location with a possibility of incorrect feedback is highlighted (marked with a circle). The operator or the like can input the corrected feedback through the input unit by operating the “correct incorrect feedback” button 1421 on the display screen.

Although one embodiment has been described above, the invention is not limited to the above embodiment, and various modifications and substitutions can be made.

For example, in the first embodiment, the operator terminal 170 and the administrator terminal 180 are connected to the management system 101 to perform feedback registration and the like. According to a modification example, the number of terminals connected to the management system 101 may be one, and either the operator or the administrator may handle the terminal. In this case, escalation is unnecessary.

In addition, the program names or the names of various tables in the first embodiment are examples, and other names may be used.

In addition, the event managed by the management system is not limited to the monitoring target system 100 or the server included therein, and may be a general information device.

What is claimed is:

1. An event management system that manages an event occurring in a monitoring target using a computer and a terminal, comprising:
a rule management table that defines situation occurrence conditions and a type of feedback;
a handling instruction sheet allocation unit that, when a new arrival event occurs, extracts a handling instruction sheet to be assigned to the new arrival event, transmits the extracted handling instruction sheet to the terminal, and receives a feedback regarding success or failure of allocation of the handling instruction sheet from the terminal; and
a feedback processing unit that detects whether or not the feedback is erroneous with reference to the rule management table,
wherein when an error in the feedback is detected, the feedback processing unit notifies the terminal of the error.

2. The event management system according to claim 1, further comprising:
an event management table that stores the event acquired from the monitoring target so as to be associated with the allocated handling instruction sheet,
wherein the handling instruction sheet allocation unit determines the new arrival event when the new arrival event is registered in the event management table.

3. The event management system according to claim 1,
wherein the feedback processing unit causes the terminal to display the handling instruction sheet having a possibility of an error in the feedback, receives an instruction to correct the error in the feedback from the terminal, and refers to the rule management table.

4. The event management system according to claim 1, further comprising:
a feedback history management table for registering information regarding the feedback,
wherein the feedback processing unit detects whether or not the feedback is erroneous with reference to the rule management table.

5. The event management system according to claim 2, wherein the event management table stores a message and a handling instruction sheet ID corresponding to an event ID unique to an event,
a handling instruction sheet management table for registering the handling instruction sheet ID, a message, and a threshold value, which serves as a criterion for allocation determination of a handling instruction sheet to be allocated, corresponding to an event is further provided, and
the feedback processing unit is able to change the threshold value when correcting the error in the feedback.

6. The event management system according to claim 1,
wherein the handling instruction sheet allocation unit morphologically analyzes an acquired message body of the event and a message in the handling instruction sheet management table, calculates a degree of matching between sentences, and determines the handling instruction sheet to be allocated based on a relationship between the degree of matching and the threshold value.

7. The event management system according to claim 5, wherein the feedback history management table manages an event ID, success or failure of feedback, a handling instruction sheet ID unique to a handling instruction sheet, and an incorrect feedback, corresponding to an event, and
the feedback processing unit causes the terminal to display the handling instruction sheet having a possibility of an error in the feedback based on a content of the feedback history management table, receives an instruction to correct the error in the feedback from the terminal, and determines whether or not the threshold value in the handling instruction sheet management table needs to be changed.

8. The event management system according to claim 3,
wherein a screen displayed on the terminal has a button for 840 giving an instruction to correct a feedback with an error, and
in response to an operation on the button, the feedback processing unit applies a correction according to the rule management table.

9. The event management system according to claim 7,
wherein the feedback processing unit statistically processes information in the feedback history management table, and causes the terminal to display information of feedback types “correct answer”, “incorrect answer”, and “missing” for each 850 handling instruction sheet.

10. The event management system according to claim 1,
wherein the rule management table stores a situation, rule/occurrence conditions, a cause/influence, and a replacement corresponding to an event number, and
the feedback processing unit detects an error in the feedback by viewing the feedback and the types with reference to the rule/occurrence conditions.

11. An event management method for managing an event occurring in a monitoring target using a computer and a terminal, comprising:
a step in which a rule management table that defines situation occurrence conditions and a type of feedback is stored in a memory;
a handling instruction sheet allocation step in which, when a new arrival event occurs, a handling instruction sheet to be assigned to the new arrival event is extracted, the extracted handling instruction sheet is transmitted to the terminal, and a feedback regarding success or failure of allocation of the handling instruction sheet is received from the terminal; and
a feedback processing step in which whether or not the feedback is erroneous is detected with reference to the rule management table,
wherein, in the feedback processing step, when an error in the feedback is detected, the terminal is notified of the error.

12. The event management method according to claim 11,
wherein the terminal displays a screen having a button for giving an instruction to correct a feedback with an error, and
in response to an operation on the button, in the feedback processing step, a correction is applied according to the rule management table.

13. The event management method according to claim 11,
wherein, in the feedback processing step, information in the feedback history management table is statistically processed, and the terminal is made to display information of feedback types “correct answer”, “incorrect answer”, and “missing” for each handling instruction sheet.
